(19) United States
(12) Patent Application Publication
(10) Pub. No.: US 2013/0024770 A1
(43) Pub. Date: Jan. 24, 2013

(54) APPARATUS AND METHOD CAPABLE OF OUTPUTTING SPATIAL INFORMATION OF DEVICE COMPONENT

(71) Applicants: JEN-HAO KANG, NEW TAIPEI CITY (TW); HSIANG-HSIEN YU, NEW TAIPEI CITY (TW)

(72) Inventors: JEN-HAO KANG, NEW TAIPEI CITY (TW); HSIANG-HSIEN YU, NEW TAIPEI CITY (TW)

(73) Assignee: COOLER MASTER CO., LTD., NEW TAIPEI CITY (TW)

(21) Appl. No.: 13/188,141

(22) Filed: Jul. 21, 2011

(51) Int. Cl. G06F 17/00

(52) U.S. Cl. 715/273

(57) ABSTRACT

An apparatus that is capable of outputting spatial information of a device component is disclosed. The apparatus includes a storage unit, a processing unit, and an output unit. The storage unit stores a component model file. The processing unit receives an accessing command which includes a reference data of the device component. The processing unit reads the component model file corresponding to the reference data according to the accessing command, and the component model file is then outputted by the output unit. Specifically, the outputted component model file includes a two-dimensional (2D) paper-based image file, which could be folded into a corresponding three-dimensional (3D) model. It is worth noting that the size of 3D model is substantially equal to the actual size of the device component represented by the 3D model.

### BACKGROUND OF THE INVENTION

1. Field of the Invention

The present invention relates to technology of outputting spatial information of a device component; in particular, to an apparatus and a method thereof that are capable of outputting the spatial information of the device component in terms of a two-dimensional paper-based file, which could be folded to form a corresponding three-dimensional model.

2. Description of Related Art

Most devices are constructed by combining different device components. For example, a computer device includes several hardware components and devices. Due to different design considerations and requirements, universal specifications for every device component are virtually non-existent. Thus, customers may have to at least ensure the size of the device component is suitable/fit to installation space where the device component is to be placed before making any purchasing decision to minimize occurrence of mismatching between the purchased items (device components) and the installation space.

However, despite the customers may be able to see the device components or visualize the device component with size information of the same, it is challenging for them to determine whether or not the selected device component matches the installation space without having the chance of actually placing the device component into the installation space.

### SUMMARY OF THE INVENTION

The present invention provides an apparatus having a storage unit, a processing unit, and an output unit. The storage unit stores at least one component model file. The processing unit is used for receiving an accessing command which includes a reference data of a device component. In addition, the processing unit may also be used for reading the component model file corresponding to the reference data according to the accessing command. The output unit is used for outputting the component model file read by the processing unit. And the outputted component model file includes a two-dimensional (2D) paper-based image file which is used for being folded into a corresponding three-dimensional (3D) model representing the device component. The size of 3D model is substantially the same as the actual size of the device component represented by the 3D model.

Moreover, the present invention also provides a method being executed on the aforementioned apparatus. The method includes receiving the accessing command having the reference data of the device component, reading the component model file corresponding to the reference data according to the accessing command, and outputting the component model file. The outputted component model file includes the 2D paper-based image file that is capable of being folded into the corresponding 3D model.

On the basis of the above, the apparatus and the method of the embodiments according to the present invention may provide the 3D model which has the same size as its counterpart, and may allow for the customer/user to confirm whether or not the chosen device component is suitable for the device, by actually placing the 3D model into the installation space.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a block diagram of an apparatus according to an embodiment of the present invention;

FIG. 2 shows a schematic diagram of a component model file according to an embodiment of the present invention;

FIG. 3 shows a block diagram of an apparatus according to another embodiment of the present invention;

FIG. 4 shows a flow chart of a method according to an embodiment of the present invention; and

FIG. 5 shows a flow chart of a method according to another embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

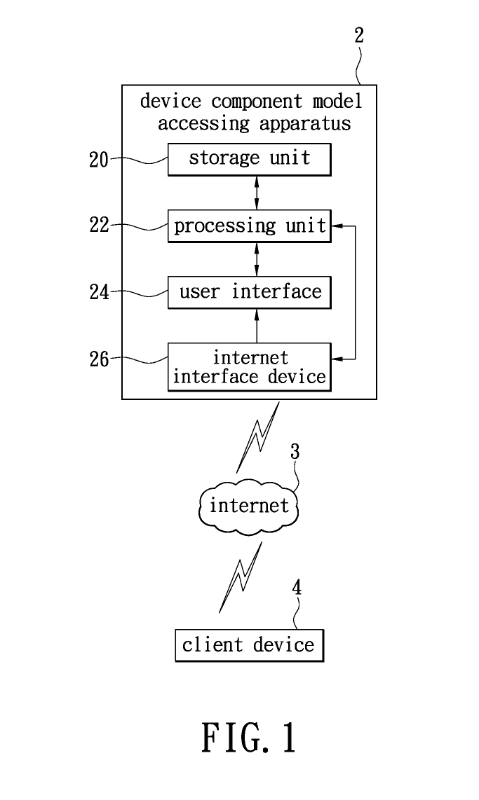

Please refer to FIG. 1. FIG. 1 is a block diagram of an apparatus 2 according to an embodiment of the present invention. The apparatus 2 includes a storage unit 20, a processing unit 22, a user interface 24, and an output unit. The output unit in this embodiment may be an internet interface device 26. The storage unit 20 storing spatial information of a device component, the user interface 24, and the internet interface device 26 are connected with and controlled by the processing unit 22.

The accessing apparatus 2 may be a server connected to an internet 3 through the internet interface device 26. A client device 4 outside the apparatus 2 may access the spatial information of the device component in the apparatus 2 via the internet 3.

Please refer to FIG. 1 again. The storage unit 20 also stores component information including identification data and a component model file corresponding to the identification data. The component information may be stored in the storage unit 20 by being recorded in a component database. The component model file includes one or more two-dimensional (2D) image file when outputted in the paper-based form may be folded into a corresponding three-dimensional (3D) model of the device component. It is worth noting that the device component may include more than one 2D image file, each of which may depict a portion of the device component. The 2D image files belonging to the same device component when outputted in the paper-based form together may be folded into the corresponding 3D model of the corresponding device component.

The processing unit 22 is for receiving an accessing command before searching for the component model file matching the accessing command. In addition, the processing unit 22 may control the output unit for outputting the component model file. In this embodiment, the processing unit 22 controls the internet interface device 26 to transmit the picked component model file to the client device 4 via the internet 3.

The remote client device 4 may be configured to input the reference data through the internet 3. The user interface 24 may prompt generation of the accessing command according to the reference data. The processing unit 22 then compares the reference data in the accessing command with the identification data in the storage unit 20. The user interface 24 may provide or display all of the identification data of the component information in the storage unit 20, allowing for human operators to select and allowing for the processing unit 22 to prompt the accessing command. Additionally, the accessing command may be prepared with specific reference data of the device component inputted through the user interface 24. The human operator may use an input device (such as a keyboard or a mouse, not shown in FIG. 1) for selecting the identification data. For example, the user may key in specific reference data or may select one of the reference data listed on the user interface 24, causing the processing unit 22 to generate accessing command accordingly. In this embodiment, the reference data of the device component and the identification data of the component information may be component numbers, product identifications, or other none-repeated series of words, numbers, or combinations of both.

The processing unit 22 may access the storage unit 20 according to the accessing command, and may compare the reference data with the identification data of the component information, in order to determine whether any identification data matches the reference data. In the event that component numbers or product identifications match the reference data, the processing unit 22 may read the component model file corresponding to that specific identification data, for outputting the corresponding component model file.

It is worth noting that the inputted reference data may be including entire or a portion of the component numbers or the product identifications. And if the processing unit 22 determines that there are more than one identification data matching the reference data, the processing unit 22 may read all of the component model files corresponding to the matching identification data.

In addition to being an output device for transmitting the component model file read by the processing unit 22 to the remote client device 4, the internet interface device 26 in this embodiment may also be used for the apparatus 2 to connect with the internet 3 (such as the Internet or a local area network). Thus, the apparatus 2 may be able to receive searching requests from the internet 3.

The device component may be peripheral component or internal component of a computer device, such as a CPU cooler, a chip set cooler, a graphics card cooler, a hard disc cooler, a computer case fan, a power supply, or any other internal components such as an expanded add-on card. Alternatively, the device component may be a side plate of a computer case, a cooler pad of a notebook computer, or any other peripheral components. Moreover, the device component may also be other piece components such as a component of an illumination device, for example, housing or a cooler device of a recessed light. In another implementation, the device component may be a spiral conduction component of any light bulb.

The component model files of the apparatus 2 may provide one or more 2D paper-based image files, all of which may be folded and combined together to form the 3D model of the device component. The 3D model thereafter may be placed into an installation space of a device for the placement of the device component, in order to determine whether the device component is fit to the installation space of the device.

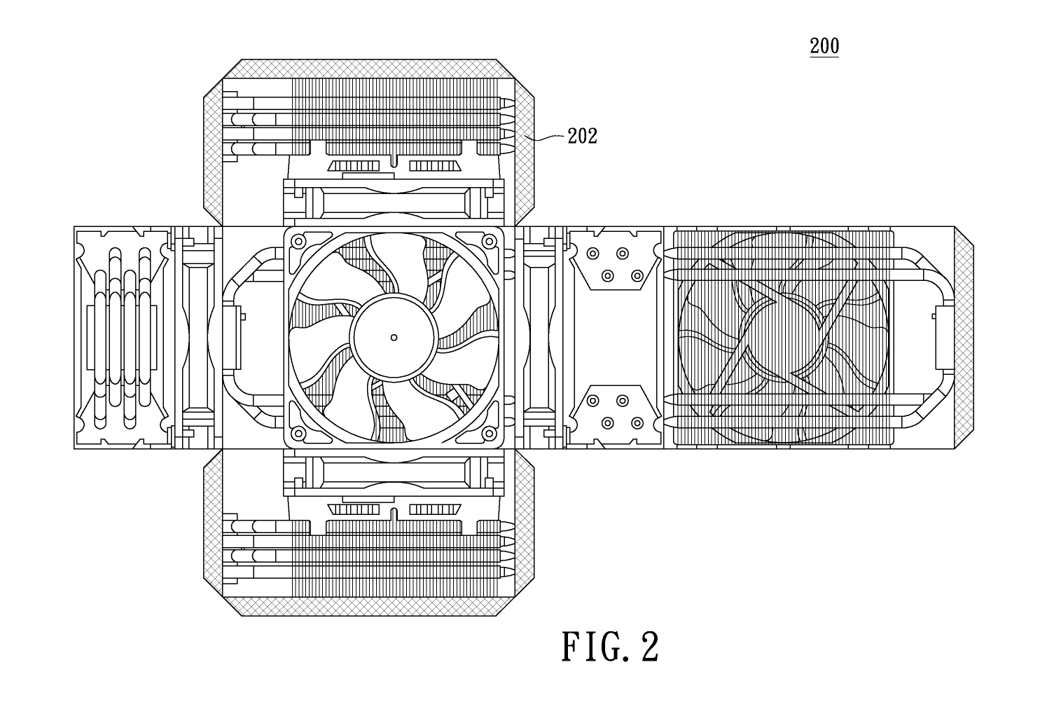

Please refer to FIG. 2 which is a schematic diagram of a component model file 200 according to an embodiment of the present invention. The component model file 200 is a 2D paper-based image file of a cooler of the specific computer product identifications or the specific component numbers. FIG. 2 shows that besides depicting the six-surface diagram in a hexahedral box form, the 2D paper-based image file also has some bonding edge strips 202 for pasting purpose so that the 2D paper-based image file may be folded into the 3D model of the specific cooler.

The 3D model may be placed into the installation space of the device in order to determine whether the 3D model representing the device component is fit to the installation space in size. It is worth noting that for precisely confirming whether or not the device component is fit to the installation space, the size of the 3D model is substantially equal to the actual size of the device component. For example, after the 2D paper-based image files in FIG. 2 are integrated into the 3D model representing the cooler with the specific product identifications or the component numbers, it may be placed into the installation space of a computer case for the placement of the cooler. The length, width, and height of the 3D model are taken into consideration for determining whether the device component represented by the 3D model is fit to the installation space or not.

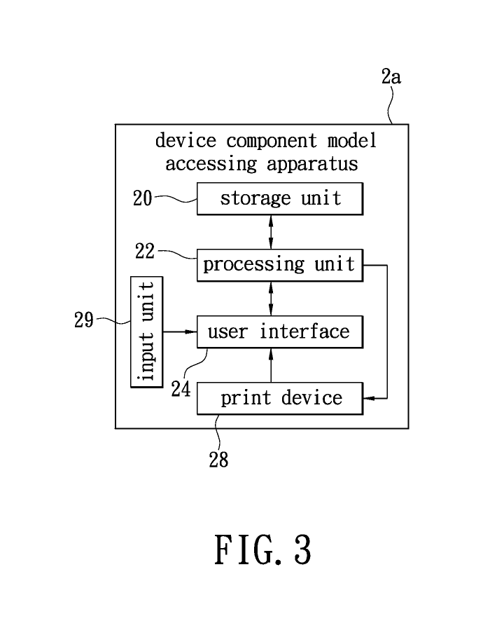

Please refer to FIG. 3 which is a block diagram of an apparatus 2a according to another embodiment of the present invention. In addition to the storage unit 20, the processing unit 22, and the user interface 26, the apparatus 2a further includes a print device 28 which serves as an output unit, and an input unit 29. The storage unit 20, the user interface 24, and the print device 28 are all electrically connected with the processing unit 22. The input unit 29 inputs and transmits the accessing commands to the processing unit 22 through user interface 24.

The apparatus 2a may be a computer device, and the storage unit 20 may be a hard disc for storing one or more component model files. The processing unit 22 may be a central processing unit, the print device 28 may be a printer, and the user interface 24 may be a graphical user interface.

When compared with the counterpart shown in FIG. 1, the storage unit 20 in this embodiment may not store the identification data. In addition, the reference data may be a save path of the component model file, for indicating the location of the component model file in the storage unit 20. The user interface 24 may display names or pictures of one or more device components of the component model files. The names and the pictures may be associated with the save paths (such as a hyperlink) of the component model files, which serve as the reference data. The clicking of the names or pictures of the device components displayed on the user interface 24 may facilitate preparation of the accessing command.

After receiving the accessing command including the reference data, the processing unit 22 may access the storage unit 20 for reading the component model files directly from the saving location according to the reference data which is the save path in this embodiment. The component model files read by the processing unit 22 may be transmitted to the print device 28 thereafter.

The 2D paper-based image file included in the component model file is used for being folded into a 3D model which has approximately the same size as the corresponding device component. If the device component is so large (such as a computer case) that cannot be represented in terms of a single sheet of paper, there may be more than one 2D paper-based image files included in the component model file, each of which represents a portion of the device component. The plurality of 2D paper-based image files of the same component model file may be respectively outputted before being integrated (folded) together to form the corresponding 3D model.

The other features of the elements in this embodiment are approximately the same as their counterparts in FIG. 1, thus they are not described repeatedly in this embodiment.

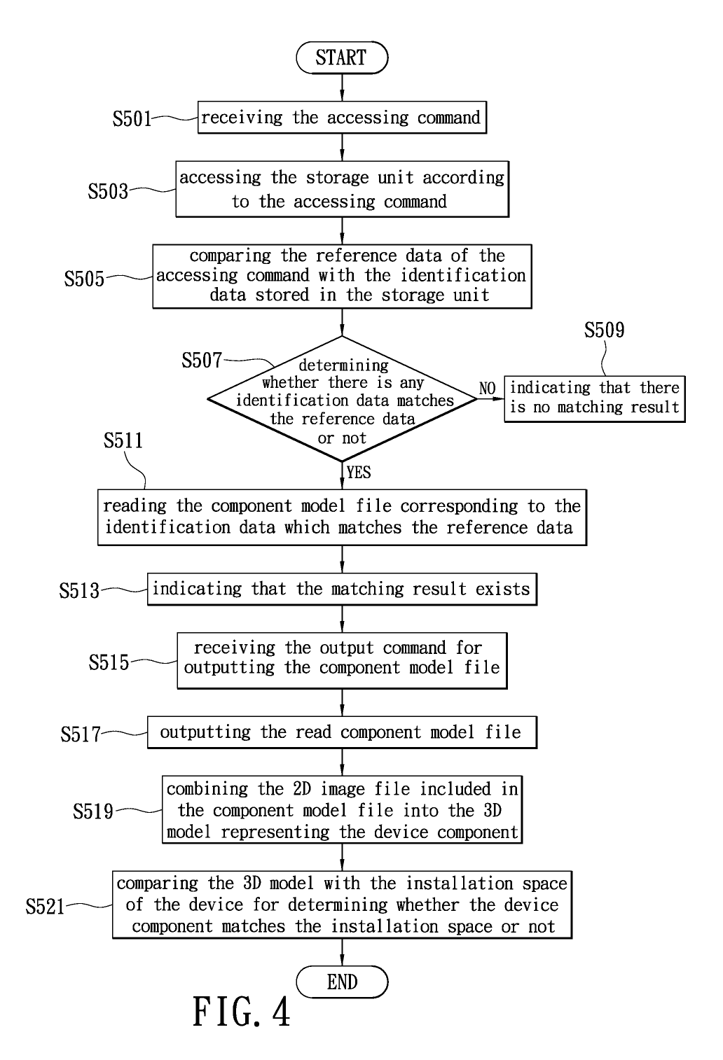

Please refer to FIG. 4, which is a flow chart of a method according to an embodiment of the present invention. The method may be executed by the apparatus shown in the FIGS. 1 and 2. For the illustration purpose, please refer to FIG. 4 in conjunction with FIG. 1.

The processing unit 22 of the accessing apparatus 2 may receive the accessing command to start the searching of the device component model (S501). The accessing command may be prepared according to inputs at the client device 4 and such inputs may be received in the form of the accessing command through the user interface 24 and the internet 3. For example, the specific product identifications or the component numbers may be inputted through the user interface 24, or selected from the list displayed on the user interface 24.

When the processing unit 22 receives the accessing command including the reference data, the processing unit 22 may access the storage unit 20 of the apparatus 2 (S503). The storage unit 20 stores one or more component information of the device components, and the component information includes the identification data of the device component and the corresponding component model file. The processing unit 22 compares the reference data with each of the identification data in the storage unit 20 according to the accessing command (S505), for determining whether any identification data matches the reference data (S507).

When the comparing result indicates that there is no identification data matching the reference data, the user interface 24 may display the message indicating the same (S509). On the other hand, when the comparing result shows that there is one or more matching, the processing unit 22 may read the component model files which correspond to the matching identification data (S511), and the read component model files may be presented to the user.

Because the processing unit 22 may find out that there are several matching identification data when some device components may partially share the same component numbers or product identification. And because the user may enter just a portion of the product identifications or the component numbers, several results partially matching the inputted reference data may be presented, and the corresponding component model files may be read. Under this situation the processing unit 22 may indicate on the user interface 24 that there are several matching results (S513). For example, more than one matching identification data (i.e. the product identifications or the component numbers) or the corresponding component model files may be displayed on the user interface 24.

The human operator may be prompted to select one of the presented component model files shown on the user interface 24, and the selected component model file may be used for the preparation of an output command (S515). The processing unit 22 may further control the output unit for outputting the component model file corresponding to the output command (S517). For example, the processing unit 22 may control the internet interface device 26 for transmitting the selected component model file to the client device 4 through the internet 3, or control the print device for directly printing the component model file.

The outputted component model file includes the 2D paper-based image file of the device component, which is for being folded to form the corresponding 3D model having substantially the same size as the corresponding device component (S519). The 3D model may be placed into the installation space of the device where the device component represented by the 3D model is going to be installed, in order to determine whether the device component represented by the 3D model is suitable for the installation space of the device (S521).

In another embodiment, for example, when the accessing command is generated by the clicking/selection of the device component listed on the user interface, the processing unit 22 may read the component model file matching the accessing command accordingly. The processing unit 22 may then control the output unit to directly output the component model file such as directly transmitting the component model file to the client device 4 through the internet 3, or directly causing the 2D paper-based image file to be printed without receiving any additional printing commands.

The specific examples of the device component and the contents of the component model file are described in the former two embodiments, thus they are not described repeatedly in this embodiment.

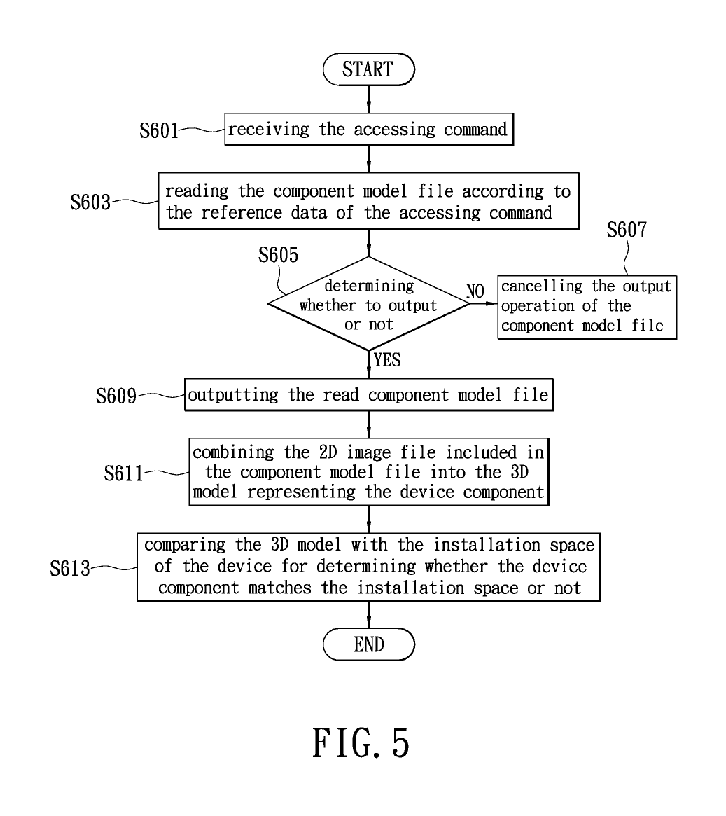

Please refer to FIG. 5 which is a flow chart of a method according to another embodiment of the present invention. The accessing method may be executed by the apparatus described in the FIGS. 1 and 3. For the illustration purpose, please refer to FIG. 5 in conjunction with FIG. 3.

The Processing unit 22 of the apparatus 2a may receive the accessing command for reading specific component model file (S601). The component model file is stored in the storage unit 20 of the apparatus 2a. The accessing command includes the reference data of the component model file such as the save path of the component model file indicative of where the component model file is stored in the storage unit 20.

The accessing command may be prepared or generated when the names or pictures of one or more device components displayed on the user interface 24 are clicked or selected.

Since the names or pictures are associated with the save paths of the corresponding component model files, upon receipt of the corresponding accessing command the processing unit 22 may go to the save path indicated by the reference data and access the storage unit 20 according to the reference data included in the accessing command, and read the component model file from the corresponding location in the storage unit 20 (S603).

After reading the component model file, the processing unit 22 may display the same on the user interface 24, and wait for further commands regarding whether to output the data read from the storage unit 20 (S605). For example, the processing unit 22 may show a message on the user interface 24 that is designed to prompt confirmation concerning whether to print the images in the component model file or not.

If no outputting of the component model file is requested, the processes of outputting the file may be canceled (S607). Otherwise, an output command may be generated accordingly to instruct the processing unit 22 to output the read component model file (S609). The component model file may be transmitted to print device 28, which generates the 2D paper-based image files of the device component, for the printing purpose.

The printed 2D paper-based image files may be integrated into the corresponding 3D model which has substantially the same size as the device component (S611). Then the 3D model may be placed into the installation space of the device where the device component represented by the 3D model is going to be installed, in order to determine whether the device component represented by the 3D model fits the installation space of the device (S613).

According to the apparatus and method of the present invention, the 3D models corresponding to different product identifications or component numbers of the device components may be provided for giving special information. Specifically, the size of the 3D model may be substantially equal to the actual size of the device component which is represented by the 3D model. In addition to allowing for customers to see patterns or standards of the device component before the purchase or the shipment of the same, the 3D model having substantially the same size as its counterpart (i.e., the actual device component) may also present the customers with opportunities to determine whether the installation space is sufficient for the placement/installation of the device components. Therefore, the inconvenience caused by the purchase of a mismatching device component may be eliminated, and the time consumed associated with the refund or the searching for the device component that fits the installation space may also be reduced.

In addition, the apparatus and the method described above may enable the printing of the searched component model file after the same has been outputted to the remote client device via the internet. Alternatively, the component model file may be directly printed by the local print device of the apparatus, to improve the efficiency of comparing the 3D model with the installation space.

Furthermore, basing on the embodiments described, the present invention may not only be used for searching and comparing the peripheral components or the internal components of a computer device or the related component of an illumination device, but may also be used for facilitating the size comparison of the device components of any other devices which have several kinds of standards, specifications, or sizes and the installation spaces where the device components are to be placed.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. An apparatus for outputting spatial information of a device component, comprising:
a storage unit which is used for storing at least one component model file of the device component;
a processing unit which is used for receiving an accessing command including a reference data of the device component, wherein the processing unit reads the component model file corresponding to the reference data according to the accessing command; and
an output unit which is used for outputting the component model file read by the processing unit;
wherein the component model file outputted by the output unit has at least one two-dimensional (2D) paper-based image file that is capable of being folded into a corresponding three-dimensional (3D) model providing the spatial information of the device component, wherein a size of the 3D model is substantially equal to an actual size of the device component.

2. The apparatus according to claim 1, wherein the 3D model is placed into an installation space defined within a device for placement of the device component, in order to determine whether the device component is fit to the installation space.

3. The apparatus according to claim 2, wherein the storage unit further stores at least one set of component information which includes an identification data and the component model file, and the processing unit compares the reference data with the identification data, wherein when the identification data matches the reference data, the processing unit reads the component model file corresponding to the identification data.

4. The apparatus according to claim 3, wherein the processing unit receives an output command and controls the output unit to output the component model file according to the output command.

5. The apparatus according to claim 1, further comprising:
a user interface presenting one or more reference data allowing for a user to select and enabling the processing unit to read the component model file according to the selected reference data;
wherein the user interface prompts generation of the accessing command according to the selected reference data, and prompts generation of the output command accordingly.

6. The apparatus according to claim 4, further comprising:
a user interface presenting one or more reference data allowing for a user to select and enabling the processing unit to read the component model file according to the selected reference data;
wherein the user interface prompts generation of the accessing command according to the selected reference data, and prompts generation of the output command accordingly.

7. The apparatus according to claim 1, wherein the output unit is a print device.

8. The apparatus according to claim 1, wherein the output unit is an internet interface device which outputs the component model file to a client device through an internet.

9. The apparatus according to claim 2, wherein the device is a computer device and the device component is a peripheral component or an internal component of the computer device.

10. The apparatus according to claim 2, wherein the device is an illumination device and the device component is a component of the illumination device.

11. The apparatus according to claim 1, wherein the component model file includes a plurality of the 2D image files that are foldable to be integrated to the corresponding 3D models.

12. A method for outputting spatial information of a device component, the method being operated on an apparatus capable of outputting the spatial information of the device component including a storage unit, a processing unit, and an output unit, the method comprising:
receiving an accessing command which includes a reference data of the device component;
reading a component model file corresponding to the reference data according to the accessing command; and
outputting the component model file;
wherein the component model file is indicative of a two-dimensional (2D) paper-based image file of the device component, and the 2D paper-based image file is capable of being folded into a corresponding three-dimensional (3D) model providing the spatial information of the device component, wherein a size of the 3D model is substantially equal to an actual size of the device component.

13. The method according to claim 12, after receiving the accessing command further comprising:
accessing the storage unit which stores at least a component information including an identification data and the component model file; and
comparing the reference data with the identification data in order to determine whether any identification data matches the reference data.

14. The method according to claim 13, wherein reading the component model file further comprises:
when the identification data matches the reference data reading the component model file corresponding to the identification data matching the reference data.

15. The method according to claim 12, after reading the component model file corresponding to the reference data, further comprising:
indicating that the component model file which is corresponding to the reference data is read; and
receiving an output command for outputting the component model file.

16. The method according to claim 14, after reading the component model file corresponding to the reference data, further comprising:
indicating that the component model file which is corresponding to the reference data is read; and
receiving an output command for outputting the component model file which is read.

17. The method according to claim 12, wherein outputting the component model file further comprises:
printing the 2D paper-based image file which is included in the component model file.

18. The method according to claim 12, wherein outputting the component model file further comprises:
transmitting the component model file to a client device through an internet.

19. The method according to claim 12, further comprising determining whether the 3D model is fit to an installation space of a device for placement of the device component by having the 3D model placed into the installation space.

20. The method according to claim 12, wherein the device component is a peripheral component or an internal component of a computer device, or a component of an illumination device.
